(19) United States
(12) Patent Application Publication
(10) Pub. No.: US 2013/0010491 A1
(43) Pub. Date: Jan. 10, 2013

(54) LIGHT GUIDE PLATE AND ELECTRONIC DEVICE WITH THE SAME

(75) Inventors: YUAN-MING WANG, Shenzhen City (CN); XUE-FENG WAN, Shenzhen City (CN); ZHAO-YONG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/205,653

(22) Filed: Aug. 9, 2011

(30) Foreign Application Priority Data
Jul. 5, 2011 (CN) 201110186609.9

(51) Int. Cl. F21V 8/00

(52) U.S. Cl. 362/551

(57) ABSTRACT

A light guide plate includes two opposite plate surfaces, two sides respectively connecting the plate surfaces. A light incident surface is defined in one side for allowing light from a light source to enter the light guide plate, and a light emission surface is defined in the other side for emitting the light. The distance between the light incident surface and the light emission surface gradually decreases as the distance between the light incident surface and the light source gradually increases.

### BACKGROUND

1. Technical Field

The present disclosure relates to light guide plates, and in particular, to a light guide plate for an electronic device.

2. Description of Related Art

Many electronic devices often include illuminating assemblies for illuminating at least part of the electronic device such that the electronic device can be used as a signal or a warning device. The illuminating assembly often includes a light guide plate, which can change the path of light emitted from a light source and illuminate the desired part of the electronic device. Therefore, the light guide plate is an essential part of the illuminating assembly and needs to emit light uniformly. However, many light guide plates cannot emit uniform light.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of an electronic device according to an embodiment of the present disclosure. The electronic device includes a housing.

FIG. 2 is an exploded view of the electronic device of FIG. 1.

FIG. 3 is a schematic view of the housing of FIG. 1.

FIG. 4 is similar to FIG. 3 but from another angle.

### DETAILED DESCRIPTION

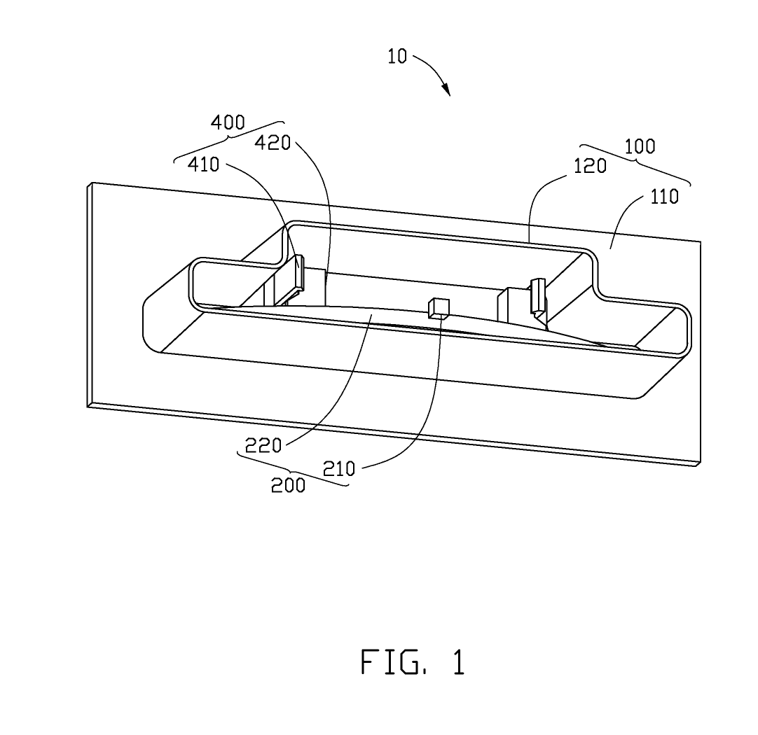

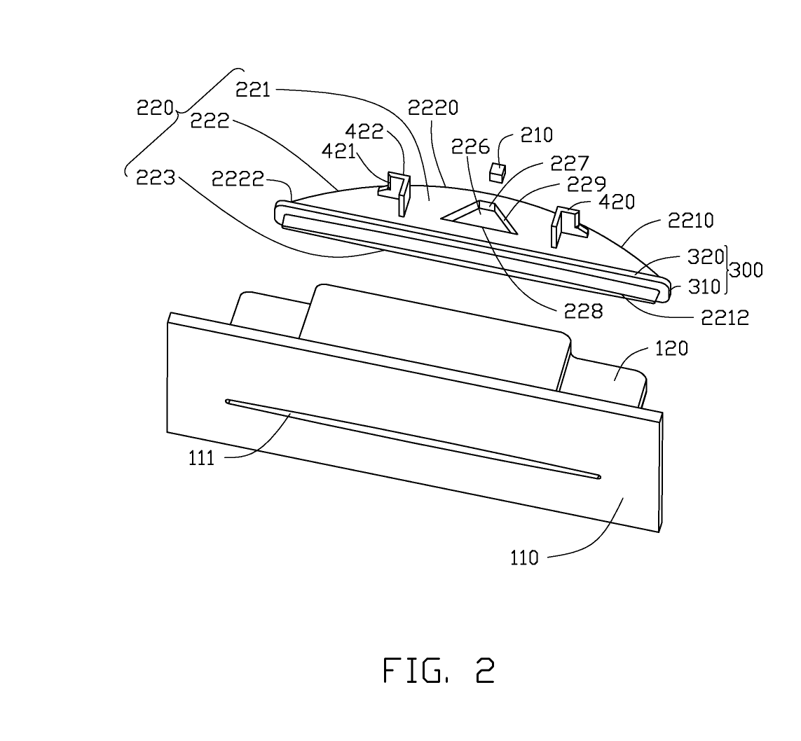

Referring to FIG. 1, an electronic device 10 includes a housing 100, an illuminating assembly 200 disposed in the housing 100, a stopper 300 disposed on the illuminating assembly 200 (see FIG. 2), and a locking structure 400 for locking the illuminating assembly 200 to the housing 100. The illuminating assembly 200 is used for emitting light for partly illuminating the housing 100 such that the electronic device 10 can be used for signaling or function as a warning device. The electronic device 10 may be any electronic device needing to be illuminated, such as a mobile phone, a notebook computer, or a DVD player, etc. And the illuminating assembly 200 may be used to highlight the electronic device.

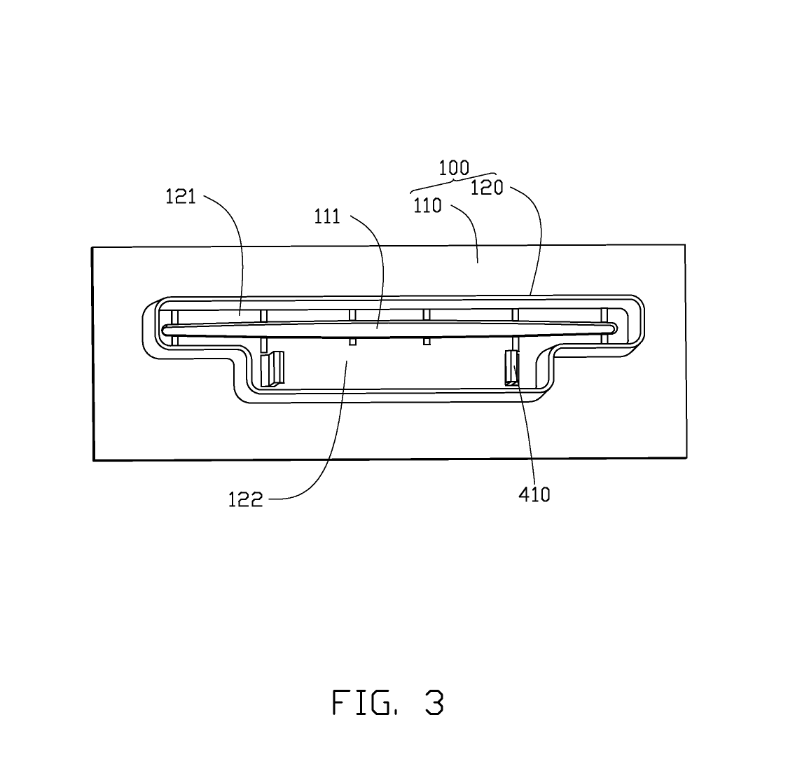

The housing 100 includes a panel 110 and a receiving portion 120 protruding perpendicularly from the panel 110 for receiving the illuminating assembly 200. A long and narrow through hole 111 (see FIG. 2) is defined in the panel 110 for allowing outward distribution of the light emitted from the illuminating assembly 200. Referring to FIGS. 2 and 3, the receiving portion 120 surrounds the through hole 111. The receiving portion 120 defines a first receiving space 121 and a second receiving space 122. The first receiving space 121 is used for receiving the illuminating assembly 200 and the stopper 300, and the second receiving space 122 is used for receiving the locking structure 400.

The illuminating assembly 200 includes a light source 210 for emitting light, and a light guide plate 220 for converting a point light flux into a planar light flux. The light source 210 is a light emitting diode in the illustrated embodiment and in other embodiments may be a fluorescent lamp or a laser. The light guide plate 220 is substantially arch shaped. The light guide plate 220 includes two opposite arch plate surfaces 221, a first side 222, and a second side 223. The two opposite arch plate surfaces 221 are substantially parallel to each other, each plate 221 includes an arch flange 2210 and a straight flange 2212. The first side 222 is symmetrically convexly arch shaped and connects the two arch flanges 2210 of the two plate surfaces 221. The second side 223 is flat and connects the two straight flanges 2212 of the two plate surfaces 221. In the illustrated embodiment, the first side 222 is a light incident surface while the second side 223 is a light emission surface. Light from the light source 210 enters the light guide plate 220 through the light incident surface and emits from the light emission surface out through the light guide plate 220.

The first side 222 of the light guide plate 220 includes two end portions 2222 and a middle portion 2220 between the two end portions 2222 corresponding to the light source 210. Since the first side 222 is symmetrically convexly arch shaped and the middle portion 2220 corresponds to the light source 210, the distance between the light source 210 and the first side 222 gradually increases from the middle portion 2220 to each end portion 2222. In this state, light intensity of the light entering the light guide plate 220 gradually decreases from the middle portion 2220 to each end portion 2222. However, the distance between the first side 222 and the second side 223 also gradually decreases from the middle portion 2220 to each end portion 2222. This results in different light loss of the light entering the light guide plate 220 through different points of the first side 220. Overall, the light loss of the light entering the light guide plate 220 through the middle portion 2220 is greater than that of the light entering the light guide plate 220 through each end portion 2222. That is, when the light enters the light guide plate 220 through a point of the light incident surface which is near to the light source 210, the intensity of the light before entering the light guide plate 220 has increased, while the light loss in the light guide plate 220 is also increased. When the light enters the light guide plate 220 through a point of the light incident surface, which is far from the light source 210, the intensity of the light before entering the light guide plate 220 is decreased, while the light loss in the light guide plate 220 is also decreased. Therefore, the arch light guide plate 220 of the illustrated embodiment can emit uniform light.

A light uniformization structure is disposed on the light guide plate 220 for allowing the light guide plate 220 to emit light having increased uniformity. The light uniformization structure corresponds to the middle portion 2220. In the illustrated embodiment, the light uniformization structure is a through hole 226 running through the two plate surfaces 221 for reflecting a portion of the light entering the light guide plate 220 through the middle portion 2220. In the illustrated embodiment, the through hole 226 is substantially trapezoidal and includes four surfaces surrounding the through hole. A first hole surface 227 adjacent to the first side 222, a second hole surface 228 opposite to the first hole surface 227, and two side hole surfaces 229 respectively connect the first hole surface 227 and the second hole surface 228. The length of the second hole surface 228 is larger than that of the first hole surface 227. Light entering the light guide plate 220 through the middle portion 2220 is partly reflected away and refracted on the first hole surface 227 and two side hole surfaces 229, and is further partly reflected and refracted on the second hole surface 228, reducing the chance of the corresponding light reaching the second side 223. Therefore, the light guide plate 220 can emit light, which has increased uniformity.

It should be understood that the light uniformization structure is not limited to this embodiment. In other embodiments, the through hole 226 may be an arch hole. In addition, the light uniformization structure is not limited to the embodiment. In other embodiments, the light uniformization structure may not be a through hole but a blind hole or other structure used for reflecting or refracting light such as a flat plate or a mirror.

Referring to FIG. 2 again, the stopper 300 surrounds the light guide plate 220 and is adjacent to the second side 223. The distance between two opposite ends 310 of the stopper 300 is larger than the length of the through hole 111, while the distance between two other opposite sides 320 thereof is larger than the width of the through hole 111. When the light guide plate 220 is received in the receiving portion 120, the stopper 300 abuts against the plate panel 110 of the housing 100 to restrict the light guide plate 220 from moving away from the housing 100 through the through hole 111 along a first direction from the first side 222 to the second side 223.

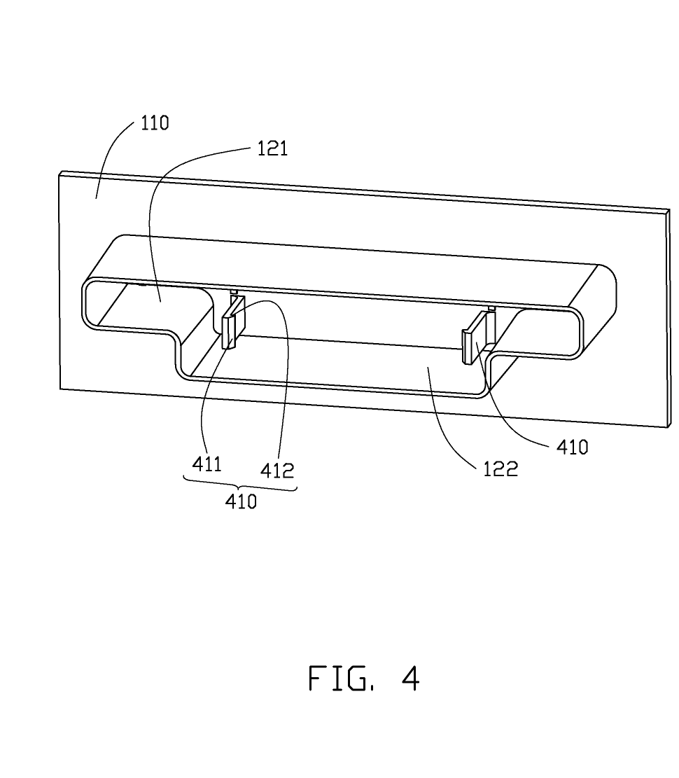

Referring to FIGS. 2 and 4, the locking structure 400 includes two first locking members 410 disposed on the housing 100 and two second locking members 420 disposed on the light guide plate 220 to respectively engage with the first locking members 410. As shown in FIG. 4, the first locking members 420 protrude from the plate panel 110 and are received in the receiving portion 120, facing each other. One side of the each first locking member 420 which is away from the plate panel 110 defines a first guiding surface 411 and an abutting surface 412 connected to the first guiding surface 411. In the illustrated embodiment, the first guiding surface 411 is an inclined surface and the abutting surface 412 is parallel to the plate panel 110.

As shown in FIG. 2, the second locking members 420 protrude from one plate 221 and are respectively located at two sides of the through hole 226. The second locking members 420 face away from each other. Each second locking member 420 is substantially L shaped and defines a second guiding surface 421 and a resisting surface 422 connected to the second guiding surface 421. During the process in which the light guide plate 220 is mounted to the housing 100, each second guiding surface 421 slidably engages with the corresponding first guiding surface 411 and each resisting surface 422 abuts against the corresponding abutting surface 412 as the second guiding surface 421 slides completely across the first guiding surface 411. Therefore, the light guide plate 220 is restricted from moving away from the housing 120 along a direction opposite to the first direction. Additionally, the first locking members 410 face each other, avoiding unwanted movement of the light guide plate 220 in the receiving portion 120.

With the arch light guide plate 220, the distance between the light incident surface and the light emission surface decreases as the distance between the light incident surface and the light source 210 increases, which reduces the light brightness difference of the light emission surface. Additionally, the light guide plate 220 can emit light with increased uniformity with the through hole 226 defined in the light guide plate 220. In addition, with the stopper 30 and the locking structure 400, the light guide plate 220 can tightly engage with the housing 100.

Even though information and the advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A light guide plate, comprising:
two opposite plate surfaces substantially parallel to each other, each plate comprising a first flange and a second flange;
two sides, one of the sides connecting the first flanges of the two plate surfaces, and the other one connecting the second flanges of the two plate surfaces;
a light incident surface defined on the side connecting the first flanges for allowing light from a light source to enter the light guide plate; and
a light emission surface defined on the side connecting the second flanges for emitting the light;
wherein the distance between the light incident surface and the light emission surface gradually decreases as the distance between the light incident surface and the light source gradually increases.

2. The light guide plate as claimed in claim 1, wherein the first side combines with the second side and the two plate surfaces to enclose the light guide plate.

3. The light guide plate as claimed in claim 2, wherein the light guide plate is arch shaped.

4. The light guide plate as claimed in claim 3, wherein the light incident surface is convexly arch shaped and the light emission surface is flat, the light incident surface has two end portions connected to the light emission surface and a middle portion corresponding to the light source.

5. The light guide plate as claimed in claim 4, wherein the two plate surfaces are both arch shaped and substantially parallel to each other.

6. The light guide plate as claimed in claim 4, wherein a light uniformization structure is disposed in the light guide plate for increasing light loss of the light entering the light guide plate through the middle portion of the light incident surface such that the light guide plate can emit light which has increased uniformity through the light emission surface.

7. The light guide plate as claimed in claim 6, wherein the light uniformization structure is a through hole.

8. The light guide plate as claimed inc claim 7, wherein the through hole is trapezoidal shaped, the through hole comprises a first hole surface adjacent to the light incident surface and a second hole surface opposite to the first hole surface, and the length of the second hole surface is larger than that of the first hole surface.

9. An electronic device, comprising:
a housing; and
an illuminating assembly; comprising:
a light source; and
a light guide plate comprising:
two opposite arch plate surfaces substantially parallel to each other, each plate comprising an arch flange and a straight flange;
a first side connecting two arch flanges of the two plate surfaces and being disposed to be a light incident surface for allowing light from the light source to enter the light guide plate; and
a second side connecting two straight flanges of the two plate surfaces and being disposed to be a light emission surface for emitting the light;
wherein the first side is arch shaped and the second side is flat.

10. The electronic device as claimed in claim 9, wherein the first side is convexly arch shaped and comprises two end portions connected to the second side and a middle portion disposed between the two end portions and corresponding to the light source.

11. The electronic device as claimed in claim 10, wherein a light uniformization structure is disposed in the light guide plate for reducing the chance of the light entering the light guide plate through the middle portion of the light incident surface to reach the light emission surface.

12. The electronic device as claimed in claim 11, wherein the light uniformization structure is a through hole running through the two plate surfaces.

13. The electronic device as claimed in claim 9, wherein the housing comprises a panel and a receiving portion protruding from the panel, the light guide plate is received in the receiving portion.

14. The electronic device as claimed in claim 13, wherein a through hole is defined in the plate panel and corresponds to the light emission surface of the light guide plate.

15. The electronic device as claimed in claim 14, wherein the electronic device further comprises a stopper disposed on the light guide plate for preventing the light guide plate from moving away from the housing through the through hole along a first direction substantially perpendicular to the plate panel.

16. The electronic device as claimed in claim 15, wherein the stopper is sleeved on the light guide plate and is adjacent to the light emission surface.

17. The electronic device as claimed in claim 15, wherein the electronic device further comprises a locking structure, the locking structure comprises at least one first locking member disposed on the housing and at least one second locking member disposed on the light guide plate for engaging with the at least one first locking member to prevent the light guide plate from moving away from the housing along a second direction opposite to the first direction.

18. The electronic device as claimed in claim 17, wherein the locking structure comprises two first locking members facing each other and two second locking members facing away from each other.
